(19) United States
(12) Patent Application Publication
(10) Pub. No.: US 2011/0045745 A1
(43) Pub. Date: Feb. 24, 2011

(54) Doped Ceria Abrasives with Controlled Morphology and Preparation Thereof

(75) Inventors: Joke De Messemaeker, Brussels (BE); Stijn Put, Turnhout (BE); Dirk Van-Genechten, Diepenbeek (BE); Yves Van Rompaey, Westerlo (BE); Daniël Nelis, Peer (BE); Yvan Strauven, Neerpelt (BE); Gustaaf Van Tendeloo, Kessel (BE)

Correspondence Address: BRINKS, HOFER, GILSON & LIONE, P.O. BOX 110285, RESEARCH TRIANGLE PARK, NC, 27709, US

(73) Assignee: UMICORE, Brussels (BE)

(21) Appl. No.: 12/866,485

(22) PCT Filed: Feb. 3, 2009
(86) PCT No.: PCT/EP2009/000679

§ 371 Date: Oct. 21, 2010

Related U.S. Application Data
(60) Provisional application No. 61/064,056, filed on Feb. 13, 2008.

(30) Foreign Application Priority Data
Feb. 8, 2008 (EP) 08002399.7

(51) Int. Cl. B24B 29/00; C09K 3/14; C09K 13/00

(52) U.S. Cl. 451/41; 428/402; 252/79.1

(57) ABSTRACT

The present invention relates to doped ceria (CeO2) abrasive particles, having an essentially octahedral morphology. Such abrasives are used in water-based slurries for Chemical Mechanical Polishing (CMP) of subrates such as silicon wafers. The invention more particularly concerns yttrium-doped ceria particles having a specific surface area of 10 to 120 m2/g, characterized in that at least 95 wt %, preferably at least 99 wt %, of the particles are mono-crystalline and in that the particles' surfaces consist of more than 70%, preferably of more than 80%, of planes parallel to {111} planes. A novel gas phase process for synthesizing this product is also disclosed, comprising the steps of providing a hot gas stream, —and, introducing into said gas stream a cerium-bearing reactant, a dopant-bearing reactant, and an oxygen-bearing reactant, —the temperature of said gas stream being chosen so as to atomize said reactant, the reactant being selected so as to form, upon cooling, doped ceria particles. Abrasive slurries based on the above ceria offer a low level of induced detectivity in the polished substrate, while ensuring a good removal rate.

The present invention relates to doped ceria (CeO₂) abrasive particles, having an essentially octahedral morphology. The abrasives are brought into a water-based slurry, for use in a Chemical Mechanical Polishing or Chemical Mechanical Planarization (CMP) process. CMP is a process to planarize structures on silicon wafers during integrated circuit manufacturing after thin film deposition steps, for example in Shallow Trench Isolation (STI) polishing.

Today, about 50% of all STI polishing is performed using ceria (CeO₂) based slurries. Even though the mechanical abrasivity of ceria is low compared to conventional abrasive particles like silica or alumina, it is particularly interesting for polishing oxide layers due to its chemical affinity for silica. Because of this high chemical affinity, removal rate and selectivity towards Si₃N₄ are high, even with a reduced ceria content in the slurry. Indeed, ceria slurries typically contain only 1 wt % of the abrasive material, whereas silica based slurries are characterized by an abrasive content of at least 12 wt % and in most cases even 20 to 30 wt %.

Another important characteristic of abrasive slurries concerns the level of defectivity they induce in the substrate. The currently available CeO₂ materials generate a too high defectivity level in CMP, certainly in view of the coming technology nodes in semiconductor manufacturing (45, 32 and 23 nm nodes), which have increasingly stringent defectivity requirements. The defectivity is essentially determined by the abrasive, and therefore it is obvious to focus developments on providing modified ceria abrasives.

As generally known, the overall polishing efficiency essentially depends on the intrinsic properties of the ceria abrasive itself (e.g. morphology, crystallographic structure, particle size distribution, purity). It is generally assumed that abrasives with a spherical morphology lead to a lower defectivity than sharp or angular particles, as is the case when polishing STI with colloidal silica against fumed silica. However, as the chemical component of the CMP process is much more important with ceria abrasives, and mechanical removal is limited to separating reaction products from the wafer under pure shear forces, it is not straightforward that spherical ceria abrasives will also result in a lower defectivity. Feng et al., in Science, 312, 1504, 2006, have prepared a spherical Ti-containing CeO₂ particle by flame synthesis, resulting in an improved CMP behavior. However, as shown by Transmission Electron Microscopy (TEM), the abrasive particle consists of an inner CeO₂ core completely encapsulated in a molten shell of titania. Since this shell results in a different surface chemistry compared to CeO₂ based particle, it is not obvious whether the improved CMP behavior can effectively be attributed to the spherical shape.

It would be highly beneficial if the synthesis of the abrasive particle could be tailored in such a way that the desired optimal morphology is obtained. Almost all state of the art ceria abrasives used in STI slurries today are produced by a precipitation and calcination process, often followed by grinding down to smaller particle size. This synthesis method leads to poly-crystalline particles. D.-H. Kim et al., Japanese Journal of Applied Physics, 45, 6A, 4893-4897, 2006, synthesized poly-crystalline particles having a typical size of a few hundred nanometers with an irregular morphology, which moreover fragment easily during application in a CMP process.

Several authors mention alloying, doping or mixing with other oxides of ceria, without referring to a specific morphology, and yielding poly-crystalline material. JP-2007-31261 discloses ceria abrasive particles which reduce scratches on silicon oxide films during polishing. These ceria particles contain one or more elements having an ionic radius larger than the ionic radius of tetravalent cerium (e.g. yttrium) and are characterized by a high crystallinity, being defined here as having a low amount of defects such as dislocations in the crystal. The particles are produced by precipitation followed by an adequate heat treatment. There is also a need for grinding the material after the calcination process.

EP-126675 describes a cerium based polishing composition obtained by mixing a solution of cerium salt, a solution of a base, such as sodium hydroxide, and a solution of at least one salt of a trivalent rare earth, which is chosen from the group consisting of the lanthanides and yttrium; filtering off the precipitate; drying and calcining it. US-2006/032836 discloses a method to prepare a polishing slurry of doped cerium oxide abrasive particles. Doping with Y is one of the numerous options. The synthesis method used is precipitation and calcination. JP-3793802 provides a method of synthesizing a ceria powder or a metal oxide-added ceria powder. However, the technology used to synthesize the particles is again a classical precipitation and calcination route, not yielding mono-crystalline particles with uniform morphology.

According to Biswas et al., Materials research Bulletin, vol. 42, no 4, 2007, pp. 609-617, doped CeO₂ is prepared using a wet chemical synthesis route. More specifically a urea-formaldehyde polymer gel combustion method is applied. Y-doping is aimed at enhancing the ionic conductivity. There is no information about the influence of Y-doping on the particle morphology. The gel combustion process in general allows limited control over process conditions and is not expected to produce a well defined particle size or morphology.

In general, ceria based slurries prepared with such standard calcined abrasives give rise to higher defectivity than equivalent silica formulated slurries. In addition, the production process of the ceria abrasives leads to broad variations in quality of the powder, which in turn leads to important batch-to-batch variations of the slurries formulated with those particles.

In principle, the above mentioned problems can be solved by applying a bottom-up gas phase synthesis route for the preparation of the CeO₂ particles. Such a method enables to control particle properties to a certain extent, by varying the process parameters such as the quenching rate, the residence time, and the temperature. In U.S. Pat. No. 7,264,787 it is shown that such an approach allows optimizing the particle size and the particle size distribution, but not the particle morphology.

US-2007/048205 describes the synthesis of CeO₂ using a hydrogen/oxygen flame. It discloses that the surface chemistry of the particles can be influenced by varying specific process conditions. The influence on the particle's morphology or the use of Y as a doping element is not mentioned.

A particle growing in a gas phase process will tend to minimize its surface energy. This will result in a particle shape where specific index planes are preponderant. Additionally, growth kinetics can also play an important role in determining the particle shape, as planes with high growth rates tend to disappear. It is observed that the powder prepared using a gas phase method is typically characterized by a truncated morphology.

It is an object of the present invention to provide a novel doped CeO₂ abrasive, containing particles having an optimized morphology for use as abrasive in CMP, resulting in a low defectivity level and a high removal rate.

To this end, and according to this invention, an yttrium-doped ceria powder is proposed, with particles having a specific surface area of 10 to 120 m²/g, and characterized in that at least 95 wt %, preferably at least 99 wt %, of the particles are mono-crystalline. The particles are additionally characterized in that their surfaces consist of more than 70%, preferably of more than 80%, of planes parallel to {111} planes.

Advantageously, the particles comprise from 0.1 to 15 at % of the doping element versus the total metal content. The particles may advantageously further consist of so-called unavoidable impurities only. Cerium is indeed typically accompanied by up to about 0.5 wt % of other lanthanides, which are considered as unavoidable impurities.

In another embodiment, this invention concerns the use of the above-mentioned particles for the preparation of a fluid mixture consisting of either one of a dispersion, a suspension, and a slurry. In a further embodiment, the above fluid mixture is defined.

The invention also concerns a gas phase process for synthesizing the yttrium-doped ceria powder described above, comprising the steps of: providing a hot gas stream; and, introducing into said gas stream a cerium-bearing reactant, an yttrium-bearing reactant, and an oxygen-bearing reactant; the temperature of said gas stream being chosen so as to atomize said reactant, the reactant being selected so as to form, upon cooling, doped ceria particles.

Preferably, the cerium-bearing reactant comprises either one or more of cerium chloride, oxide, carbonate, sulphate, nitrate, acetate, and an organo-metallic cerium compound. Moreover, the yttrium-bearing reactant could advantageously comprises either one or more of a metal chloride, oxide, carbonate, sulphate, nitrate, acetate, and an organo-metallic metal compound.

In a particularly advantageous embodiment, the oxygen-bearing reactant is embodied by either one or both of the cerium-bearing reactant and the yttrium-bearing reactant.

The hot gas stream can be generated by means of either one of a gas burner, a hot-wall reactor, and a radio frequency or direct current plasma. The gas stream can be quenched immediately after the formation of doped ceria particles. This could avoid unwanted particle growth during a relatively slow cooling cycle.

A still further embodiment of the invention concerns the process of polishing a substrate, comprising the steps of: providing a CMP apparatus comprising a substrate carrier, a rotating polishing pad, and means for feeding an abrasive slurry onto the polishing pad; placing the substrate to be polished on the substrate carrier; pressing the substrate against the rotating polishing pad; and, feeding an adequate amount of abrasive slurry onto the polishing pad; characterized in that said abrasive slurry is the above-defined fluid mixture.

This process is particularly suitable for polishing substrates comprising a coating of either one or more of silicon dioxide, silicon nitride, copper, copper barrier and tungsten, or consists of a glass-like surface.

Excellent results were thus achieved by applying a gas phase synthesis process, combined with the addition of a doping element. ‘Doping’ in this context means incorporating a doping element in the fluorite lattice of the CeO₂, by substitution of a small part of the Ce⁴⁺ ions with the doping element's ions. This may cause oxygen deficiency, increase lattice strain and change the zeta-potential, and as a consequence it may also affect the different surface energies and as such bring the energy of high index planes closer to those of low index planes.

When used to polish thin films (e.g. SiO₂) in a CMP process during the manufacturing of semiconductor integrated circuits, the obtained particles give rise to a lower defectivity compared to state-of-the-art ceria abrasives and with a comparable removal rate.

The crystal structure of ceria (CeO₂) is cubic, according to the Fm-3m space group. The unit cell is made up of a face-centered cubic (fcc) cerium lattice and a cubic oxygen cage within this fcc cerium lattice. Due to this fcc structure, the shape of small-sized ceria particles is dominated by the truncated octahedron, defined by {100} and {111} facets. Some high-index facets like the {113} facet can also be present, but in much smaller amounts. This is due to the larger surface energy of these high index planes. A few higher-order surfaces are observed, leading sometimes to rounded corners or shapes.

To acquire a statistical shape distribution, the powders are dispersed by adding methanol to the powder in a mortar and agitating gently. Drops of the dispersion are deposited on carbon-film TEM support grids. High Resolution Transmission Electron Micrographs (HR-TEM) are recorded. Thirty images at sufficiently high magnification are taken for indexing and visual confirmation of the statistical distribution. For particle analysis, 100 particles in clear view on the TEM images are selected.

Of these particles, the {111} planes and {100} planes are indexed and counted.

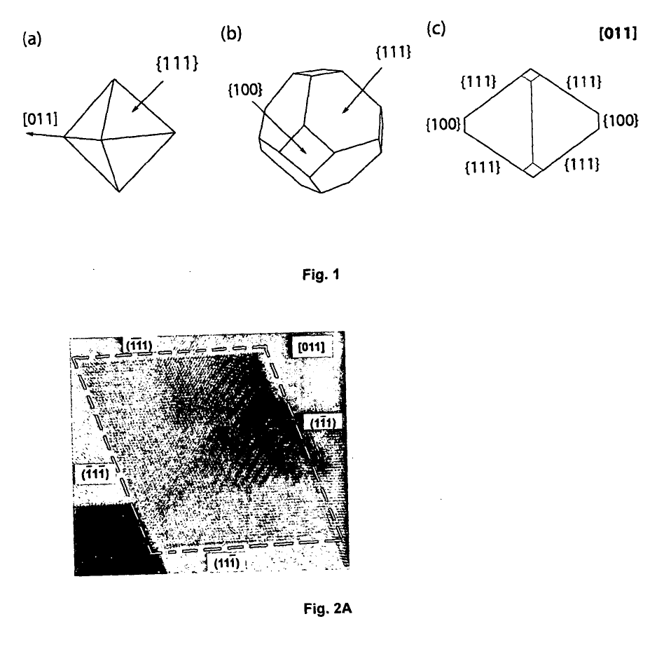

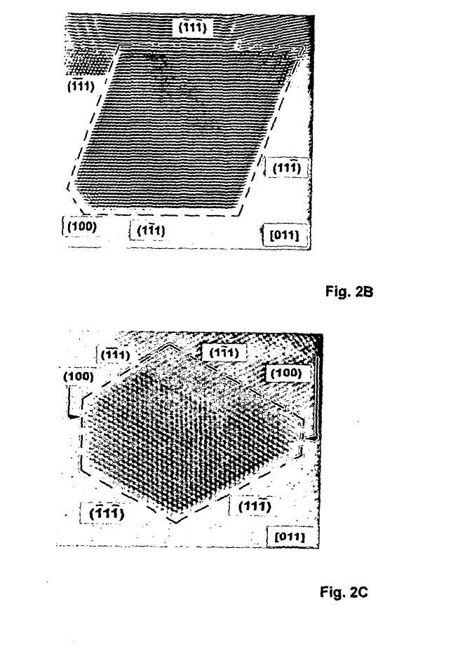

In FIG. 1, the predominant particle shapes, which are the octahedron (FIG. 1A) and the truncated octahedron, are shown (FIG. 1B). The truncated octahedron is also shown in [011] zone axis, the zone axis in which the particles are mostly imaged (FIG. 1C). It is clear from this Figure that almost all ceria nano-particles have surfaces dominated by {111} and {100} type facets.

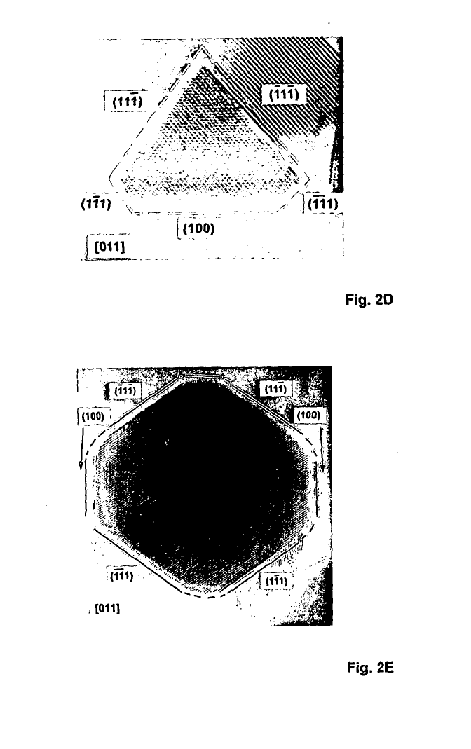

FIGS. 2A-E show different examples of (truncated) octahedron type doped ceria particles.

### EXAMPLES

1. The starting material is prepared by mixing an aqueous Ce-nitrate solution with an aqueous Y-nitrate solution in such a way that the Y-content amounts to 5 at % compared to the total metal content. A 100 kW radio frequency inductively coupled plasma is generated, using an argon/oxygen plasma with 12 Nm³/h argon and 3 Nm³/h oxygen gas. The mixed Y- and Ce-nitrate solution is injected in the plasma at a rate of 500 mL/h, resulting in a prevalent (i.e. in the reaction zone) temperature above 2000 K. In this first process step the Y/Ce-nitrate is totally vaporized followed by a nucleation into Y-doped CeO₂. An air flow of 10 Nm³/h is used as quench gas immediately downstream of the reaction zone in order to lower the temperature of the gas below 2000 K. In this way the metal oxide nuclei will be formed. After filtering a nano-sized Y-doped CeO₂ powder is obtained, characterized by the fact that the doping element is fully incorporated into the CeO₂ lattice. The specific surface area of the resulting powder is 40±2 m²/g (BET), which corresponds to a mean primary particle size of about 20 nm.
2. The apparatus according to Example 1 is operated in similar conditions. However, the starting solution is prepared in such a way that it contains 2.5 at % Y compared to the total metal content. After filtering a nano-sized Y-doped CeO₂ powder is obtained, characterized by the fact that the doping element is fully incorporated into the CeO₂ lattice. The specific surface area of the resulting powder is 40±2 m²/g (BET), which corresponds to a mean primary particle size of about 20 nm.
3. (Comparative) The apparatus according to Example 1 is operated in similar conditions. However, the starting solution is a pure Ce-nitrate solution without any added Y. After filtering a nano-sized pure CeO₂ powder is obtained, with a specific surface area of 40±2 m²/g (BET). This corresponds to a mean primary particle size of about 20 nm.
4. (Comparative) A 250 kW direct current plasma torch is used, with nitrogen as plasma gas. The gasses exit the plasma at a rate of 150 NW/h. A Ce-nitrate solution is injected downstream of the plasma, at a rate of 25 kg/h. In this step, the reactants are vaporized, resulting in a prevalent gas temperature higher than 2000 K, and nucleate as CeO₂ powder. Further downstream, air is blown at a flow rate of 6000 Nm³/h resulting in a reduction of the gas temperature. After filtering, a nano-sized CeO₂ powder is obtained. The specific surface area of the resulting powder is 40±2 m²/g (BET), which corresponds to a mean primary particle size of about 20 nm.
5. The apparatus according to Example 4 is operated in similar conditions. However, the starting solution is prepared in such a way that it contains 2.5 at % Y compared to the total metal content. After filtering a nano-sized Y-doped CeO₂ powder is obtained, characterized by the fact that the doping element is fully incorporated into the CeO₂ lattice. The specific surface area of the resulting powder is 40±2 m²/g (BET), which corresponds to a mean primary particle size of about 20 nm.
6. The apparatus according to Example 4 is operated in similar conditions, however with a plasma power of 400 kW and an air flow rate of 5000 Nm³/h. In this way a nano-sized Y-doped CeO₂ powder is obtained with a specific surface area of 30±3 m²/g (BET), which corresponds to a mean primary particle size of about 30 nm.
7. The apparatus according to Example 4 is operated in similar conditions, however with a plasma power of 400 kW and an air flow rate of 15000 Nm³/h. In this way a nano-sized Y-doped CeO₂ powder is obtained with a specific surface area of 80±5 m²/g (BET), which corresponds to a mean primary particle size of about 11 nm.
8. The method according to Example 7, however with a Ce/Y-acetate solution as starting material. In this way a nano-sized Y-doped CeO₂ powder is obtained with a specific surface area of 100±10 m²/g (BET), which corresponds to a mean primary particle size of about 10 nm.
9. The apparatus according to Example 4 is operated in similar conditions, however with a plasma power of 400 kW and an air flow rate of 3000 Nm³/h. In this way a nano-sized Y-doped CeO₂ powder is obtained with a specific surface area of 12±2 m²/g (BET), which corresponds to a mean primary particle size of about 80 nm.

All powder samples contained at least 95 wt % mono-crystalline particles as confirmed by TEM and XRD analyses. Table 1 gives an overview of the percentage of {111} and {100} planes present in the powder samples according to the TEM method explained in the previous paragraphs. It is clear that the yttrium doped samples all have more {111} planes compared with the undoped ceria powder. Of the planes which are not {111}, Table 1 shows that 50% or more are {100}, indicating that the shape of the doped ceria particles is also dominated by the (truncated) octahedron type.

TABLE 1
Morphology results

| | | | Ex. 3 | Ex. 4 | | | | | |
|---|---|---|---|---|---|---|---|---|---|
| | Ex. 1 | Ex. 2 | (Comp.) | (Comp.) | Ex. 5 | Ex. 6 | Ex. 7 | Ex. 8 | Ex. 9 |
| Yttrium (at % | 5.0 | 2.5 | 0 | 0 | 2.5 | 2.5 | 2.5 | 2.5 | 2.5 |
| vs. total metal) | | | | | | | | | |
| BET (m²/g) | 40 | 40 | 40 | 40 | 40 | 30 | 80 | 100 | 12 |
| % {111} planes | 94 | 80 | 61 | 65 | 88 | 75 | 80 | 82 | 72 |
| % {100} planes | 5 | 11 | 30 | 24 | 8 | 15 | 10 | 9 | 19 |

10. An yttrium doped ceria powder with 5 at % Y prepared as described in Example 1 is mixed with water and poly-acrylic acid at a pH of 10 (using KOH), such that the resulting ceria content is 1 wt % and the weight of the poly-acryl chains is 3.4% of the weight of the ceria, and the mixture is then sonicated for 10 min. The mixture is then brought on a polishing pad rotating at 40 rpm, and during 1 min a Si wafer with a deposited SiO₂ film rotating at 65 rpm is pressed against the pad with a pressure of 4 psi. The wafer is then rinsed, cleaned and dried. The resulting film thickness loss as measured by ellipsometry is 69 nm. The wafer is then dipped in a 0.2% HF bath until 15 nm of the remaining SiO₂ film has dissolved, and then rinsed and dried such that no water marks remain on the surface. The resulting number of defects on the film surface larger than 0.15 μm as measured by dark field laser light scattering is 3752. Both results are considered to be satisfying.
11. An yttrium doped ceria powder with 2.5 at % Y prepared as described in Example 2 is brought in a mixture which is used for polishing a Si wafer with deposited SiO₂ film as described in Example 10. The resulting film thickness loss before dipping in the HF bath is 75 nm. The resulting number of defects larger than 0.15 μm after dipping in the HF bath is 1750. Both results are considered to be satisfying.
12. (Comparative) A pure ceria powder prepared as described in Comparative Example 3 is brought in a mixture which is used for polishing a Si wafer with deposited SiO₂ film as described in Example 10. The resulting film thickness loss before dipping in the HF bath is only 59 nm, which is too low. The resulting number of defects larger than 0.15 μm after dipping in the HF bath is 6916. This figure is considered inadequately high.

1-13. (canceled)

14. Yttrium-doped ceria particles having a specific surface area of 10 to 120 m²/g, wherein at least 95 wt % of the particles are mono-crystalline, and wherein the particles' surfaces consist of more than 70% of planes parallel to {111} planes.

15. The yttrium-doped ceria particles of claim 14, wherein the particles comprise 0.1-15 wt % of doping element versus the total metal content.

16. The yttrium-doped ceria particles of claim 14, wherein the particles further comprise unavoidable impurities.

17. A fluid mixture comprising the yttrium-doped ceria particles of claim 14.

18. A gas phase process for synthesizing the yttrium-doped ceria particles of claim 14, comprising:
providing a hot gas stream; and
introducing into said gas stream a cerium-bearing reactant, an yttrium-bearing reactant, and an oxygen-bearing reactant,
wherein the temperature of said gas stream is chosen so as to atomize said reactant, said reactant being selected so as to form, upon cooling, yttrium-doped ceria particles.

19. The process of claim 18, wherein the cerium-bearing reactant comprises one or more of cerium chloride, carbonate, oxide, sulphate, nitrate, or acetate, or an organo-metallic cerium compound.

20. The process of claim 18, wherein the yttrium-bearing reactant comprises one or more of an yttrium chloride, carbonate, oxide, sulphate, nitrate, or acetate, or an organo-metallic yttrium compound.

21. The process of claim 18, wherein the oxygen-bearing reactant is embodied by either one or both of the cerium-bearing reactant or the yttrium-bearing reactant.

22. The process of claim 18, wherein the hot gas stream is generated by a gas burner, a hot-wall reactor, a radio frequency or direct current arc plasma.

23. The process of claim 18, wherein, after the formation of yttrium-doped ceria particles in the gas stream, the gas stream is quenched.

24. A process for polishing a substrate, comprising:
providing a CMP apparatus comprising a substrate carrier, a rotating polishing pad, and means for feeding an abrasive slurry onto the polishing pad;
placing the substrate to be polished on the substrate carrier;
pressing the substrate against the rotating polishing pad; and
feeding an adequate amount of abrasive slurry onto the polishing pad,
wherein said abrasive slurry is a fluid mixture according to claim 17.

25. The process of claim 24, wherein said substrate comprises a coating of one or more of silicon dioxide, silicon nitride, copper, copper barrier or tungsten, or comprises a glass-like surface.

26. The yttrium-doped ceria particles of claim 14, wherein at least 99 wt % of the particles are mono-crystalline.

27. The yttrium-doped ceria particles of claim 14, wherein the particles' surfaces consist of more than 80% of planes parallel to {111} planes.
